(19) United States
(12) Patent Application Publication
(10) Pub. No.: US 2008/0161957 A1
(43) Pub. Date: Jul. 3, 2008

(54) Transaction Interface for Standardizing Transactions with a Measurement Instrument

(76) Inventors: Thomas A. Rice, Marysville, CA (US); Morihiro Ryu, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/536,587

(22) Filed: Sep. 28, 2006

(51) Int. Cl. G06F 19/00

(52) U.S. Cl. 700/108

(57) ABSTRACT

A transaction interface sits between a client application and hardware of a measurement instrument. The client application submits queries to the transaction interface to determine what capabilities the measurement instrument possesses. The query conforms to a standard format required by the transaction interface. The transaction interface executes the query and returns a response to the client application. The response includes the instrument capabilities. The client application then utilizes the desired capability of the instrument.

### BACKGROUND OF THE INVENTION

Test and measurement instruments (e.g. signal capture and analysis instruments such as spectrum analyzers, oscilloscopes, multimeters, network analyzers; signal source instruments such as signal generators, DC sources, and other waveform or power sources) are used across a product's entire life cycle to design, debug, manufacture, test, and maintain the product.

Different instruments within the same instrument family are often used at different stages in the product life cycle. For example, there are many kinds of spectrum analyzers within the spectrum analyzer family of instruments. A spectrum analyzer used during the research and design (R&D) phase of a cellular phone is usually more sophisticated and has more capabilities than a spectrum analyzer used in manufacturing to test thousands of phones from an assembly line. Similarly, the R&D spectrum analyzer is typically bigger than a portable spectrum analyzer used in the field to test a cellular base station. However, all three spectrum analyzers (the R&D, manufacturing, and portable spectrum analyzers) need to be capable of making many of the same measurements, calculations, and algorithms. The measurements, calculations, algorithms, computational logic, etc. that each instrument is capable of performing shall hereinafter be collectively referred to as “measurement intellectual property” or “measurement IP”.

In the past, instruments were designed to have the measurement IP directly and implicitly aware of both the hardware composition and limitations of the product. This approach bound the measurement IP to the hardware and prevented reuse of the measurement IP across different instruments, both within the same instrument family as well as across different families. For example, a sweep algorithm in a prior art spectrum analyzer would be designed to be inherently aware of the specifics of the hardware within the spectrum analyzer. The sweep measurement would be pre-customized to the hardware capabilities and limitations of the spectrum analyzer. As a result, product developers and users have had to rework or even recreate their most valuable and difficult measurement IP across the different instruments. In the example given above for the three different kinds of spectrum analyzers, a command to perform an AC-coupled sweep could be implemented three different ways to accommodate the different hardware present in the three different instruments.

Another difficulty was in determining if errors or variations in results were due to actual problems in a device under test (DUT), or simply differences in implementations of the measurement IP. In the past (using the example given above), if the same measurement (e.g. an error vector magnitude measurement) were performed on the three kinds of spectrum analyzers, and a different result was obtained from each spectrum analyzer, it was difficult to determine the reason for the variance. Was there an actual problem in the DUT (e.g. cell phone, base station, etc.)? Or did the difference stem from variations in implementation of the measurement algorithm? The answer was difficult to ascertain in the past.

Prior attempts to solve these problems included using the same syntax, such as defined by the Standard Commands for Programmable Instrumentation (SCPI). SCPI defines a standard set of commands to control test and measurement instruments by specifying a command structure and syntax to control programmable instruments. However, using the same syntax was insufficient to eliminate the rework needed between instrument types and platforms, because the same command could mean different things in different instruments. Even if the command had the same meaning across different instruments, it could be implemented differently and return different results. Furthermore, the SCPI code for the spectrum analyzer does not overlap much with the oscilloscope, so there is not much reusability or savings by using SCPI.

### SUMMARY OF THE INVENTION

A solution to these problems is provided by using a transaction interface. The transaction interface sits between measurement instrument hardware (or a simulation of the measurement instrument hardware) and a client application that provides the measurement IP. The transaction interface is a set of guidelines which components in a measurement system follow in their interactions with each other. The transaction interface is implemented using a transaction server.

The transaction interface provides a common syntax and common semantics for transactions between the client application and the instrument hardware. The transaction interface also allows for measurement IP portability between instruments within a family (e.g. between an R&D spectrum analyzer, a manufacturing spectrum analyzer, and a portable spectrum analyzer), as well as between different families of instruments (e.g. between a spectrum analyzer, an oscilloscope, a frequency counter, etc.).

The transaction interface requires that the capabilities of a measurement instrument are discoverable by the client application. The client application determines those capabilities by submitting a query to the transaction interface. The transaction server initiates the proper hardware routines to determine the capabilities and returns those capabilities to the client application, which then utilizes the desired capabilities. However, the client application and instrument hardware do not communicate directly with one another—all communication between them passes through and is facilitated by the transaction interface.

By using the transaction interface consistently across different instruments within a family, the rework needed to implement measurements, calculations and other algorithms is reduced. The transaction interface can be used across different families of instruments as well. The capabilities and results are both standardized and versioned. Using a transaction form allows for efficient remote deployments of hardware from the measurement IP.

### BRIEF DESCRIPTION OF THE DRAWINGS

FIG. 1 shows a high-level diagram of one embodiment of a measurement instrument (such as a spectrum analyzer) that includes a transaction interface made according to the present invention.

FIGS. 2A-C are flow charts that describe the transactions between the client application, the transaction interface, and the instrument hardware.

FIG. 3 illustrates how the transaction interface creates portability and reusability of measurement IP.

FIG. 4 is a software model that illustrates one possible implementation of the transaction interface.

FIG. 5 shows examples of the transaction interface implemented across a network.

FIG. 6 is an analysis model diagram in Unified Modeling Language (UML) of a transaction interface according to one embodiment of the present invention.

### GLOSSARY

For the description of the present invention, the following terms shall have the meanings here set forth:

“Measurement instrument” means any instrument used to determine a characteristic or parameter of a device under test. This definition includes instruments such as signal sources, which create signals that are used in a measurement, for example signals that serve as a reference or standard in a measurement. The term “measurement instrument” is used interchangeably with “test and measurement instrument” and “instrument”. Examples of measurement instruments include (but are not limited to): spectrum analyzers, network analyzers, logic analyzers, protocol analyzers, oscilloscopes, multimeters, voltmeters, power meters, frequency counters, impedance analyzers, signal sources, and Electronic Design Automation (EDA) software such as the simulation products produced by EEsof EDA, a division of Agilent Technologies, Inc. of Santa Clara, Calif.

“Measurement intellectual property” or “Measurement IP” means any calculation, measurement, computational logic, or algorithm that is performed either on measurement instrument data, or to generate measurement instrument data (with respect to signal sources). Examples of measurement IP include, but are not limited to: making error vector magnitude measurements, carrier power measurements, generating specific waveforms, such as WCDMA reference pilot signals, etc.

“Measurement” means any measurement of an aspect of fundamental physics, such as a measurement of voltage, time, frequency, power, current, resistance, inductance, capacitance, S parameters, Z parameters, etc.

“Instrument family” means a collection of similar instruments that have varying degrees of capabilities or sophistication, but have similar purposes. For example, within the spectrum analyzer instrument family are the R&D spectrum analyzer, the manufacturing spectrum analyzer, and the portable spectrum analyzer. Spectrum analyzers are not in the same family as oscilloscopes, which are not in the same family as network analyzers, etc. However, there may be some overlap between measurements across different families. For example, a sweep measurement can be run in both a spectrum analyzer as well as an oscilloscope.

“Client application” means any software program or application that utilizes a capability of a measurement instrument. The term “client application” is used interchangeably with “client”.

“Transaction” means an interaction between a client application and the transaction interface. Every transaction has an explicit requester. Errors and return values are reported only to that requester. Each transaction is unique to a client/server pair and is not affected by any concurrent transactions by other requesters.

### DETAILED DESCRIPTION

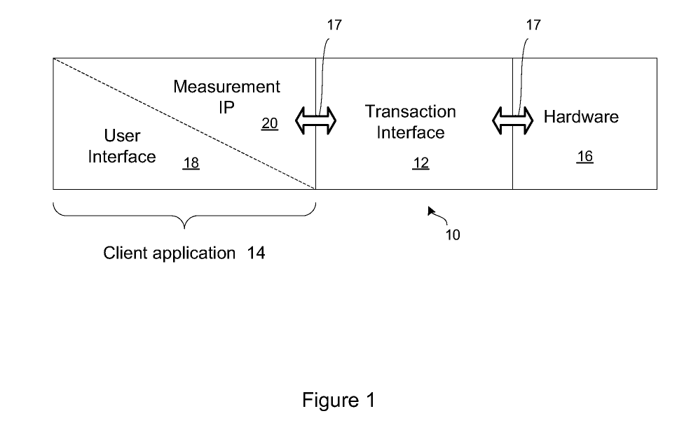

FIG. 1 shows a high-level diagram of one embodiment of a measurement instrument 10 (such as a spectrum analyzer) that includes a transaction interface 12 made according to the present invention. For the sake of discussion and ease of comprehension for the reader, all examples hereinafter will assume that the measurement instrument 10 is a spectrum analyzer. However, it should be understood that the present invention is not limited to spectrum analyzers and is applicable to all measurement instruments.

The transaction interface 12 is analogous to a contract with a set of requirements, which components in a measurement instrument follow in their interactions with each other. The requirements of the transaction interface 12 are implemented using a transaction server (not shown in FIG. 1).

The transaction interface 12 sits between a client application 14 and the hardware 16 of the measurement instrument 10. The transaction interface requires a standard format for transactions between the client application and the instrument hardware, and uses a common syntax and common semantics for these transactions. A user interacts with and controls the instrument via the client application 14, which initiates all transactions. A ticket identification (ID) is assigned to each transaction. The ticket ID is globally unique. The client application 14 includes a user interface 18 that the user uses to set parameters for a measurement, execute a measurement, etc. More importantly, the client application 14 includes measurement IP 20 that is performed on data collected by the instrument hardware 16.

The hardware 16 includes the hardware driver and other low-level, hardware-related firmware that communicates directly with the instrument hardware. The client application 14 does not need to be aware of the specifics of the instrument hardware or how a measurement is implemented on a particular instrument, since it is not in direct communication with the hardware 16. Instead, as indicated by arrows 17, the client application 14 communicates only with the transaction interface 12, and the hardware 16 communicates only with the transaction interface 12. The hardware 16 collects measurement data from a device under test (DUT, not shown). The data sent back by the hardware is corrected or “cleaned-up” to compensate for deficiencies in the hardware prior to being sent back to the client application. The data sent back by the transaction server is to maintain the client application's independence from the hardware functionality or quality.

It should be noted that the transaction interface 12 can also be used in systems where the instrument hardware 16 is replaced with a software simulation of the hardware, which is common for development purposes. Simulations are often used before the hardware is available in a design cycle, as well as for the design process itself.

The transaction interface 12 provides a common syntax and common semantics for communications between the client application 14 and the instrument hardware 16. By using the transaction interface 12, measurement IP 20 can be reused between instruments within a family (e.g. between an R&D spectrum analyzer, a manufacturing spectrum analyzer, and a portable spectrum analyzer), as well as between different families of instruments (e.g. between a spectrum analyzer, an oscilloscope, a frequency counter, etc.). This increased portability eliminates the rework that needed to be done in the past to implement similar measurements within and across instrument families.

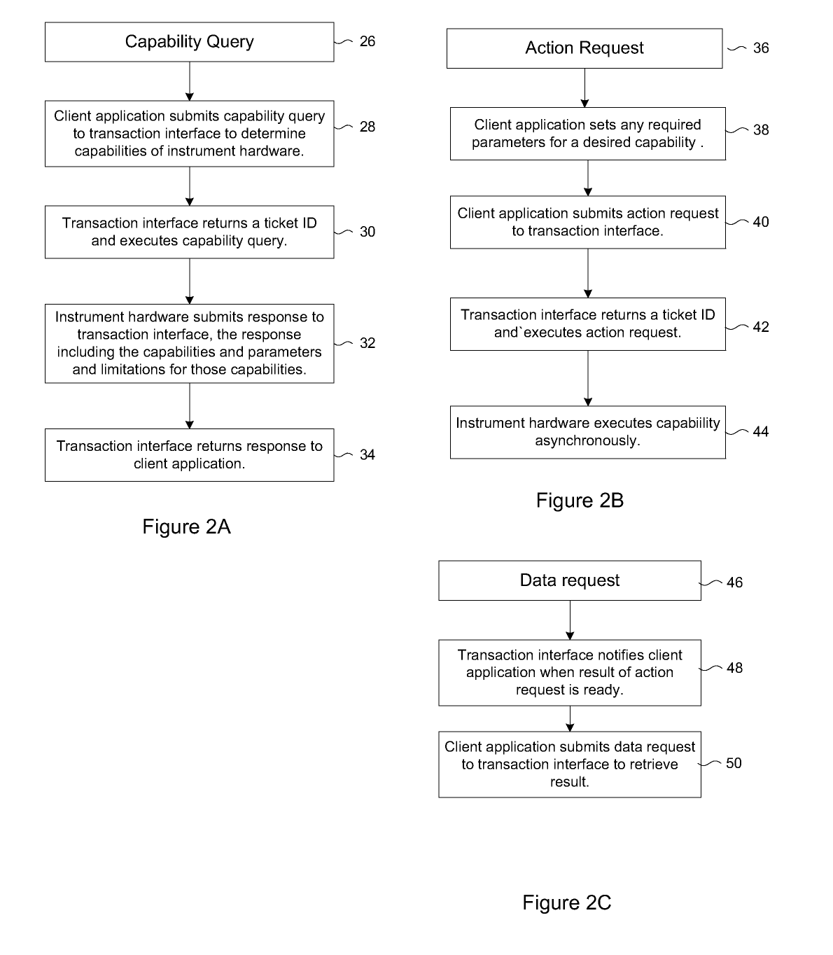

FIGS. 2A-C are flowcharts that describe the interaction between the client application 14, the transaction interface 12, and the instrument hardware 16 of FIG. 1. There are 3 primary transactions that occur within the measurement system: capability queries (26); action requests (36); and data requests (46). All parts of the transactions are standardized and purely value-typed. When invoked, a transaction has a copy of its parameters. This copy is per-requester (e.g. per client application), and will not be affected by any concurrent transactions by other requesters. Invalid parameters are treated as a fatal error (no adjusting).

FIG. 2A is a flow chart that describes a capability query 26. A client application uses a capability query to determine what capabilities the instrument possesses. First in step 28, the client application submits a capability query 26 to the transaction interface 12. Next in step 30, the transaction interface 12 returns a ticket ID for the query, and executes the capability query asynchronously by performing any hardware-specific inquiries the transaction server 12 may need to do. Then in step 32, the instrument hardware submits a response to the transaction interface, the response describing which capabilities are available to the client application 14. The response should also include parameters such as the limitations of the instrument, the accuracy and precision of its measurements, etc. The capabilities returned by the hardware in its response can be a subset of its full set of capabilities. For example, in some licensing schemes, a client application 14 may be limited as to what hardware capabilities it is allowed to utilize, based on how broad a license has been purchased by the user. In such a situation, the returned set of capabilities in the hardware response may be a subset of the hardware's complete capabilities.

Finally in step 34, the transaction interface 12 passes the response back to the client application 14. The capability query 26 is performed at initialization, when the instrument is first powered on. The client application 14 can also subscribe to notifications from the hardware 16 (discussed below), so that changes in the hardware capabilities can be used to trigger another capability query.

FIG. 2B is a flow chart that describes an action request 36 by the client application 14 to use a capability of the instrument, after the client application 14 has submitted a capability query 26 and received a response as described above in the flow chart of FIG. 2A. In step 38, the client application 14 sets any required parameters for the capability it desires to use. For example, a client application 14 desiring to use the sweep function of the spectrum analyzer would have to set parameters of frequency start and frequency stop, sweep time, resolution bandwidth, detector, etc. Invalid parameters are treated as a fatal error (no adjusting). After setting these parameters, the client application submits an action request 36 to the transaction interface 12 to utilize the desired capability in step 40. In our spectrum analyzer example, the client application 14 would submit an action request to run a sweep with the parameters it previously set. Next in step 42, the transaction server returns a ticket ID and executes the action request 36, again performing any hardware-specific routines. The instrument hardware executes the requested capability asynchronously in step 44.

FIG. 2C is a flow chart that describes the process of a data request 46, which happens after an instrument has finished executing an action request 36, e.g. the results of the sweep. In step 48, the transaction interface 12 notifies the client application 14 that the data/result from the action request 36 is ready. The transaction interface 12 can do so by simply referring to the ticket ID issued previously in during the action request 36. Next, in step 50, the client application submits a data request to the transaction interface to retrieve the result, again referring to the ticket ID. The transaction interface 12 retrieves the data/result in step 52 and returns it to the client application 14. If for some reason the instrument is unable to complete the execution of the requested capability, then the transaction interface 12 returns an error message referring to the ticket ID of the transaction as a result.

Action requests can be implemented hierarchically, and refer to results from previous data requests and results, as well. Furthermore, the capability queries and action requests are versioned to remain adaptable.

In an alternate embodiment, the transaction interface 12 can return the data/result to the client application 14 as soon as it is ready and available. The client application 14 does not need to fetch the data itself.

In order to communicate with the transaction interface 12, every capability query, action request, and data request submitted by the client application 14 must conform to a standard format specified for the transaction. Similarly, every response and result notification submitted by the hardware to the transaction server must also conform to the same standard format. All data are value-typed, which means that they can be fully and independently represented without pointers or implied connections to other programming constructs. A ‘C’ programming language struct which contains no pointers or function references is an example of a value-type. By requiring the hardware and the client application to communicate via the transaction server using standard formats, interoperability is achieved between instruments within a family, and between families of instruments. The client application does not need to be aware of the specifics of how the capability queries, action requests or data requests are implemented by the instrument, because that is hidden from the client application behind the transaction server. The particular standard format selected for the capability queries, requests, settings, results, etc., are designed so as to not be inherently dependent upon any particular operating system (OS) or remoting technology.

The client application initiates all capability queries, action requests, and data requests. The hardware only responds to transactions initiated by the client application, except in a few cases. One case is when the hardware capabilities of the instrument change. For example, the instrument may gain additional capabilities, such as when new electronics (e.g. a new circuit board) are hot-plugged into the instrument. The instrument may lose capabilities as well, such as when existing electronics are hot-swapped out of the instrument, or when something (e.g. a circuit or component) fails in the instrument. In either situation, the hardware server must send a notification broadcast via the transaction interface to the client application relating the change in capabilities.

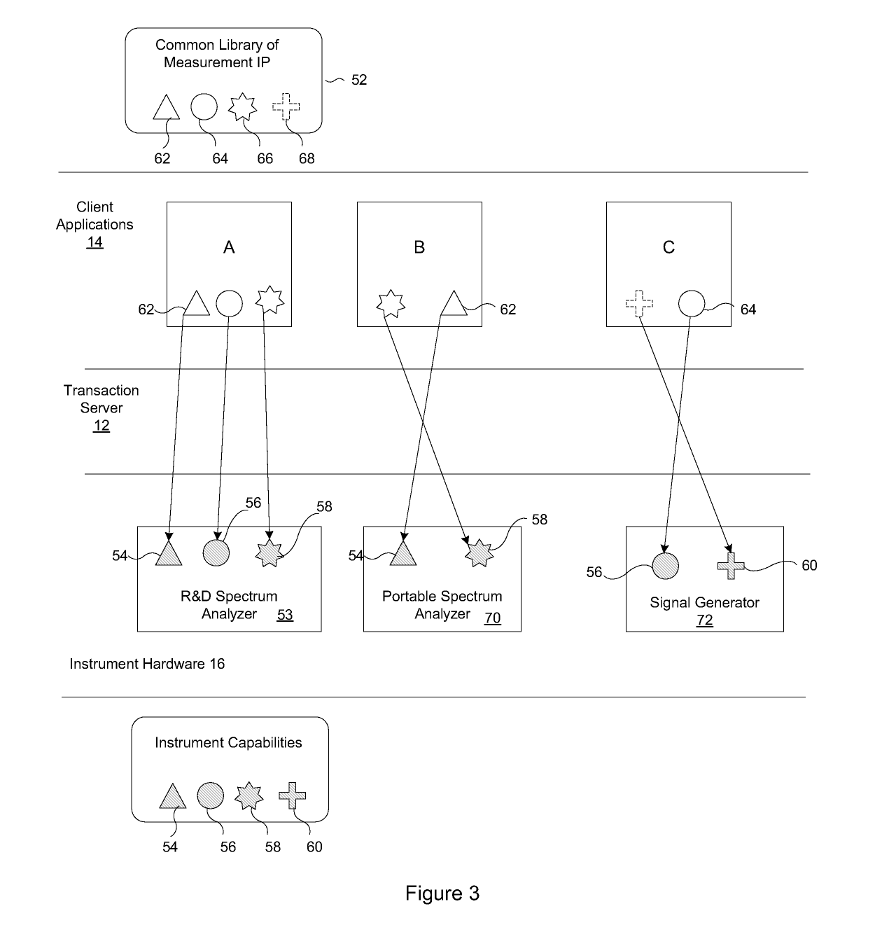

FIG. 3 illustrates how the transaction interface 12 creates portability and reusability of measurement IP. The transaction interface 12 brings standardization into communications between hardware 16 and the client application 14. Once a particular measurement IP module has been developed, it can be used over and over again for different instruments and client applications. The client application is no longer tied to a particular instrument. The advantages to the present invention are seen when the transaction interface is used across different instruments in a family, or across families of instruments. Since there is a standard transaction interface, a designer of a particular client application need only select from a common library 52 of measurement IP to plug into and use in the client application 14.

For example, suppose an R&D spectrum analyzer 53 has 3 capabilities, represented by the symbols triangle 54, circle 56, and star 58. (Only 3 capabilities are shown for the sake of simplicity, but in reality, a spectrum analyzer will have much more than just 3 capabilities). Suppose also that measurement IP has been developed to utilize these capabilities, represented by the hollow symbols of a triangle 62, a circle 64, and a star 66. The desired measurement IP is taken from the common library and plugged into client application A that is designed to work with the R&D spectrum analyzer 53. The transaction interface standardizes client application A's communications with the R&D spectrum analyzer 53.

Suppose that, some time later, a portable spectrum analyzer 70 is being developed. Its hardware provides similar but fewer capabilities than the R&D spectrum analyzer 53. The capabilities of the portable spectrum analyzer 70 are represented by triangle 54 and star 58. Notice that the portable spectrum analyzer 70 has fewer capabilities than the R&D spectrum analyzer 53. In the past, the developer of client application B needed to start from scratch to develop measurement IP (or at least substantially rework measurement IP) to utilize the portable spectrum analyzer's capabilities. The transaction interface of the present invention allows the developer to pick and choose which components in the common library 52 of measurement IP to plug into the client application B and reuse the measurement IP previously developed. Any relevant limitations in the portable spectrum analyzer's capabilities that should be taken into account by the measurement IP will be made known to client application B using a capability query as described previously.

For example, suppose the shaded triangle 54 represents a sweep capability, and the hollow triangle 62 in the common library represents a sweep algorithm. The R&D spectrum analyzer 53 is capable of performing a sweep up to X GHz, whereas the portable spectrum analyzer 70 is only capable of performing a sweep up to Y GHz. The sweep algorithm (triangle 62) in the common library 52 is implemented generically, with a variable instead of a hardcoded frequency limitation. The client application submits a capability query to the corresponding instrument and determines its capabilities and limitations, include the frequency limitation in a sweep measurement. Once it receives a response from the instrument hardware, the client application simply plugs in the proper limitation into the sweep algorithm. For the R&D spectrum analyzer, client application A would plug in X GHz into sweep algorithm 62. For the portable spectrum analyzer, client application B would plug in Y GHz into sweep algorithm 62. In this way, the same sweep algorithm can be used across different instruments in the same family. A developer of a client application no longer needs to reinvent or redevelop his own measurement IP.

A similar savings can be applied across instrument families as well. A developer of a signal generator 72 can plug in any measurement IP that exists already in the common library that is shared with the R&D spectrum analyzer 53, as represented by circle 64. For example, one capability that might be shared across these two different families (spectrum analyzer and signal source) is a bit error rate test. Any new measurement IP (as represented by the dashed cross 68) that does not currently exist in the common library for the signal generator's capabilities can be created, and added to the common library for future reuse.

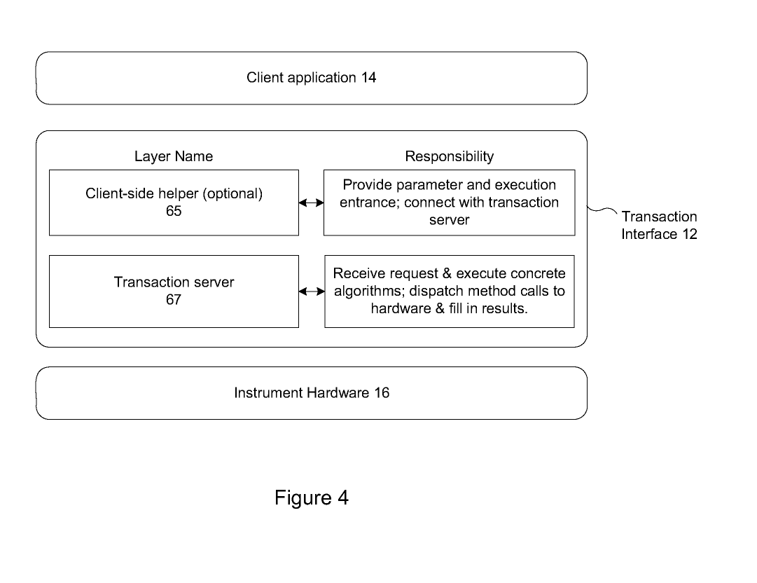

FIG. 4 is a software model that illustrates one possible implementation of a transaction interface 12. In one embodiment, the transaction interface has two layers: a client-side helper 65, and a transaction server 67. The client-side helper 65 communicates with the client application to provide an entrance for setting parameters and utilization requests. It also connects with the transaction server 67. The client-side helper 65 is optional, as the client application can be designed to communicate directly with the transaction server 67.

All transactions between the client application 14 and the instrument hardware 16 are handled by the transaction server 67, which can be in-process or remote. The transaction server 67 receives requests from the client-side helper 65 and executes concrete algorithms. It also dispatches method calls to the instrument hardware and fills in the results of the execution for later retrieval. Both layers work asynchronously. The transaction server 67 is capable of supporting multiplicity (multiple clients and multiple servers) and concurrency (fulfilling/executing multiple requests at the same time). The transaction server 67 can be utilized through a direct application programming interface (API) and through industry standard remote access mechanisms, including Web Services.

In an actual reduction to practice, the transaction interface 12 was implemented using C sharp in a .NET environment. However, any suitable software/programming language and environment may be used to implement the transaction interface 12.

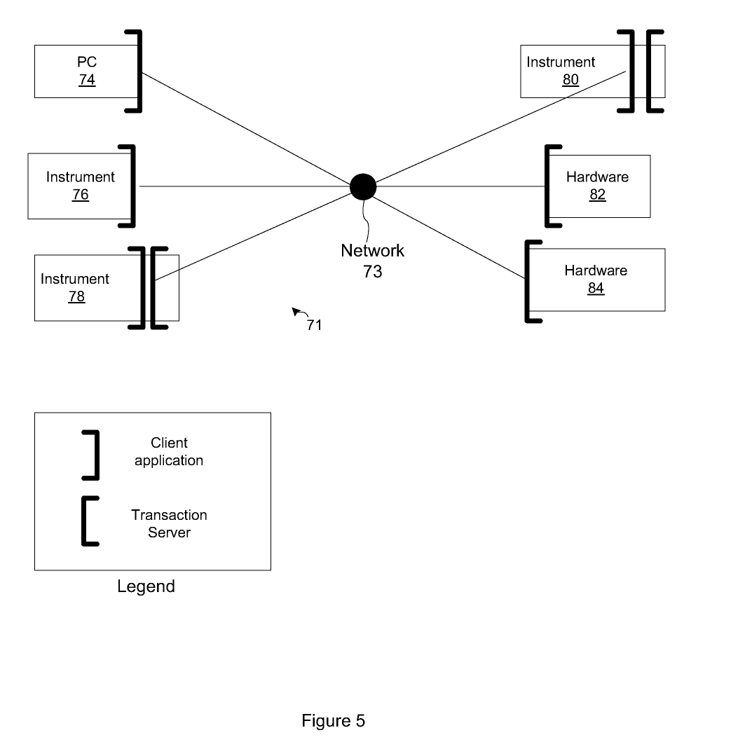

Use of the transaction interface is not limited to within a measurement instrument alone—a transaction interface can be used in networked measurement systems as well. FIG. 5 is a measurement system 71 which shows examples of how the transaction interface can be used across a network 73. The system 71 includes the following components that are connected to the network 73: a personal computer (PC) 74 and an instrument 76, each having a client application but no transaction server; two instruments 78 and 80, each having both a client application and a transaction server; and hardware 82 and hardware 84, which are stripped down instruments containing instrument hardware and a transaction server only with and no client application installed. The transaction interface supports Any component having a client application can connect to and use the capabilities of any component having a transaction server, using the transactions (capability query, action request, and data request) previously described.

For example, suppose a user of the PC 74 desires to run a sweep measurement. The PC 74 itself has no measurement instrument hardware installed. Instead, the client application on PC 74 can send a capability query out onto the network 73. Every component having a transaction server would send back a response with its respective capabilities. Suppose instrument 80 is an oscilloscope, hardware 82 is spectrum analyzer hardware (with no local client application), and hardware 84 is signal source hardware (with no local client application). The responses of instrument 80 (the oscilloscope) and hardware 82 (the spectrum analyzer hardware) would include sweep capabilities, whereas the response of hardware 84 (the signal source hardware) would not. After determining which capabilities are available over the network 73, the user of PC 74 can determine which sweep capabilities fit his needs and send out action requests to the appropriate instrument.

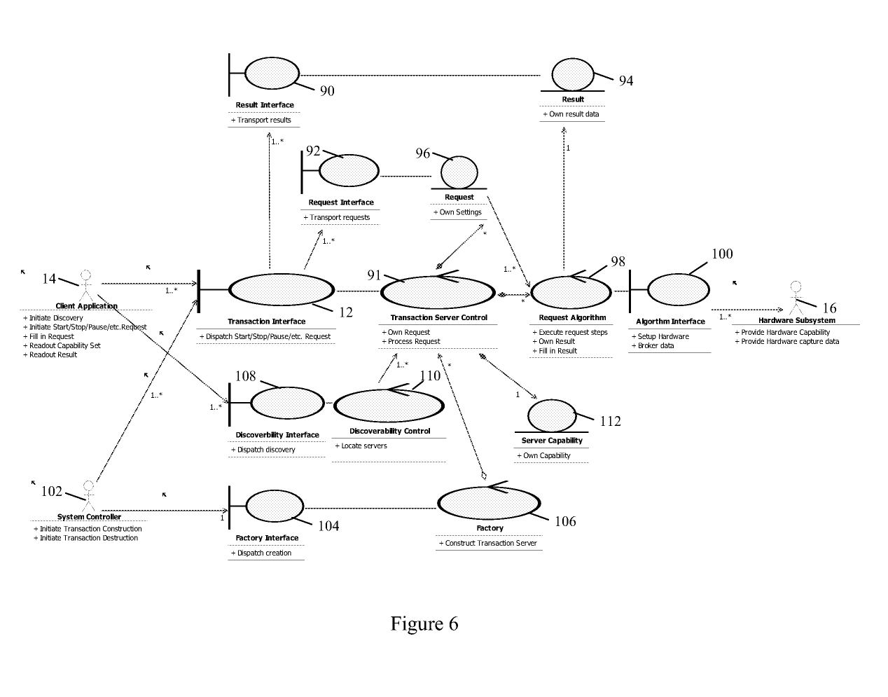

FIG. 6 is an analysis model diagram in Unified Modeling Language (UML) of a transaction interface according to one embodiment of the present invention. The client application 14 has the responsibilities of initiating discovery, initiating start/stop/pause/etc. requests (e.g. for capability queries, action requests, and data requests), filling in requests, reading out capability set, and reading out result.

The client application communicates with the transaction interface 12. The transaction interface 12 communicates with a request interface 92. The request interface 92 transports requests from the client application 14. The transaction interface 12 also has the responsibilities of dispatching start/stop/pause requests. The dispatch of start/stop/pause requests is owned and processed by the transaction server control 91.

The request interface 92 communicates with a request entity 96, which owns the input parameters passed from the client application 14. The request entity 96 communicates with the request algorithm 98. The request algorithm 98 is software that knows how to communicate with the hardware subsystem to execute the request. The request algorithm 98 is responsible for executing request steps, owning the result, and filling in the results.

The request algorithm 98 communicates with the hardware subsystem 16 through an algorithm interface 100. The algorithm interface 100 has the responsibilities of setting up the hardware and brokering data. The hardware subsystem 16 provides the hardware capabilities and captures the data requested, then returns it via the algorithm interface 100 to the request algorithm 98. The request algorithm 98 stores the data in the result entity 94, which owns the result data.

The transaction interface 12 communicates with the result interface 90, which communicates with the result entity 94. When the client application 14 is notified that the result is ready, it retrieves the result through the transaction interface 12 and the result interface 90.

The transaction server control 91 owns a server capability 112. The server capability 112 is an entity that holds the capabilities of the server, such as what types of requests the transaction server can process.

The client application 14 also communicates with a discoverability interface 108. The client application 14 uses the discoverability interface 108 to discover what transaction servers may be available. The discoverability interface 108 is responsible for dispatching discoveries and communicates with a discoverability control 110. The discoverability control 110 finds and communicates with the transaction server control 91 to determine which transaction servers the client application 14 can connect to over a network.

A system controller 102 exists to instantiate a transaction server. The system controller 102 is responsible for initiating construction and destruction of a transaction interface. The system controller 102 communicates with a factory interface 104. The factor interface 104 communicates with a factory control 106 to dispatch the creation of a transaction server control 91.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A method for performing a measurement, comprising:
submitting a query to a transaction interface for an instrument to determine what capabilities the instrument possesses, the query conforming to a standard format for the transaction interface;
executing the query;
returning a response to a client application, the response including a capability of the instrument and conforming to the standard format; and
utilizing the capability of the instrument.

2. A method as in claim 1, wherein utilizing the capability comprises:
setting any relevant parameters for the capability;
submitting a first request to the transaction interface to utilize the capability with the set parameter;
executing the first request and generating a result conforming to the standard format; and
notifying the client application that the result is available.

3. A method as in claim 2, further comprising:
submitting a second request to the transaction interface to retrieve the result once it is available.

4. A method as in claim 2, further comprising:
returning the result to the client application when notifying the client application that the result is available.

5. A method as in claim 3, wherein submitting the first request includes referencing a previous request.

6. A method as in claim 3, wherein the response includes a limitation of the capability.

7. A method as in claim 3, wherein the client application is software including measurement intellectual property (IP).

8. A method as in claim 7, wherein the measurement IP is re-used in a second client application.

9. A method as in claim 3, the transaction interface further comprising:
a client-side helper for communicating with the client application; and
a transaction server in communication with the client application and hardware of the instrument, the transaction server having means for receiving and fulfilling requests from the client application.

10. A method as in claim 3, wherein the client application, hardware, and transaction interface are integrated into the instrument.

11. A method as in claim 3, wherein the client application communicates with the transaction interface across a network connection.

12. A method as in claim 3, wherein the transaction interface can be used in at least two different instruments within an instrument family.

13. A method as in claim 3, wherein the transaction interface is used in two different instruments from two different instrument families.

14. A method as in claim 3, further comprising
broadcasting to the client application any change in the capabilities of an instrument.

15. A method as in claim 3, wherein the instrument is represented by a software simulation.

16. A method as in claim 3, wherein the client application sends queries onto the network to determine what capabilities exist to be used.

17. A measurement system, comprising:
a client application;
a measurement instrument having hardware and a set of capabilities; and
a transaction interface between the client application and the hardware, wherein:
the client application queries the transaction interface to determine the set of capabilities possessed by the measurement instrument,
the transaction interface executes the query and responds to the client application with the set of capabilities, and
the client application utilizes a capability from the set of capabilities.

18. A measurement system as in claim 17, wherein:
the client application sets up any relevant parameters to utilize the capability;
the client application submits a first request to the transaction interface to utilize the capability with a set parameter;
the transaction interface executes the first request and the instrument hardware generates a result; and
the transaction interface notifies the client application that the result is available.

19. A measurement system as in claim 18, wherein:
the client application submits a second request to the transaction interface to retrieve the result once it becomes available.

20. A measurement system as in claim 18, wherein the transaction interface further comprises:
a client-side helper for communicating with the client application; and
a transaction server in communication with the client application and hardware of the instrument, the transaction server further receiving and fulfilling requests from the client application.
